(19) United States
(12) Patent Application Publication
(10) Pub. No.: US 2007/0220053 A1
(43) Pub. Date: Sep. 20, 2007

(54) Multimedia playing apparatus capable of searching for digital multimedia information

(75) Inventors: Steel Su, Sijhih City (TW); Toon-Jeow Foo, Singapore (SG)

Correspondence Address: MCDERMOTT WILL & EMERY LLP, 18191 VON KARMAN AVE., SUITE 500, IRVINE, CA, 92612-7108, US

(73) Assignee: Behavior Tech Computer Corp., Sijhih City (TW)

(21) Appl. No.: 11/717,078

(22) Filed: Mar. 13, 2007

(30) Foreign Application Priority Data
Mar. 17, 2006 (TW) 095109120

(51) Int. Cl. G06F 7/00

(52) U.S. Cl. 707/104.1

(57) ABSTRACT

A multimedia playing apparatus capable of searching for digital multimedia information uses a corresponding media descriptor downloaded from the media transmitting source. The multimedia playing apparatus includes a reception module and a comparison module. The reception module is used to receive at least the media descriptor corresponding to the digital multimedia information. The comparison module is used to compare the media descriptor with a search rule to determine if the media descriptor conforms to the search rule.

### FIELD OF THE INVENTION

This application relates to a multimedia playing apparatus, and more particularly, to a multimedia playing apparatus capable of searching for digital multimedia information.

### BACKGROUND OF THE INVENTION

Digital Audio Broadcasting (DAB) is a technology which processes audio signals for broadcasting by a full course of digital technique. This enables replaying the original sounds in fidelity after the digital audio signals are transmitted, which is unlike the conventional analog signals which are susceptible to various types of interference resulting in distortion during transmission. Therefore, DAB is the third generation broadcasting technology which follows AM and FM. There are some other similar digital broadcasting technologies, such as Digital Video Broadcasting (DVB), Internet Protocol Broadcasting, Digital Satellite Broadcasting (DSB), and Digital Sound Broadcasting (DSB). Among these digital broadcasting technologies, DAB, DVB, and Internet Protocol Broadcasting are the most popular technologies.

These digital broadcasting technologies transmit digital multimedia information through various transmission channels and have proprietary reception modes and approaches, respectively. For example, DVB is classified into Digital Video Broadcasting-Satellite (DVB-S and DVB-S2), Digital Video Broadcasting-Cable (DVB-C), Digital Video Broadcasting-Terrestrial (DVB-T), and Digital Video Broadcasting-Handheld (DVB-H), by transmission channels.

The digital multimedia information generally can be sorted out into three types: video, picture, and audio. The formats of video type at least include Divx, Xivd, H.264, RA, WMV, AVI, MPEG, and QuickTime. The formats of picture type at least include JPG, BMP, and TIFF. The formats of audio type at least include RA, WMA, MP3, WAVE, MIDI, and AIFF.

No matter what type of digital broadcasting technology is used, since generally the transmitted digital multimedia information is not in pure text file, the user-desired search pattern cannot be quickly and conveniently obtained by way of search engine, like Google. Few digital multimedia information providers provide relevant information, such as name of author, title, abstract, serial number, copyright information, etc. via web pages, so that a search engine can utilize these information. However, not all providers provide the information for search purpose.

Therefore, there is a need for a multimedia playing apparatus which is capable of providing search and monitoring services by conventional search mechanisms using media descriptors embedded in the digital multimedia information or downloaded with the multimedia information, so as to enable users to find the target digital multimedia information more easily and conveniently.

### SUMMARY OF THE INVENTION

The main objective of the invention is to provide a multimedia playing apparatus capable of searching for digital multimedia information. The multimedia playing apparatus performs search, monitoring and control based on the downloaded media descriptor corresponding to the digital multimedia information, and performs comparison on the basis of the search rules. When the comparison result is HIT, the multimedia playing apparatus stores the corresponding digital multimedia information or plays back the corresponding digital multimedia information in real time.

In accordance with one aspect of the invention there is provided a multimedia playing apparatus which uses a corresponding media descriptor downloaded with the digital multimedia information. The multimedia playing apparatus includes a reception module to receive at least the media descriptor; and a comparison module to compare the media descriptor with a search rule to determine if the media descriptor conforms to the search rule.

In accordance with another aspect of the invention there is provided a multimedia playing apparatus which uses a corresponding media descriptor downloaded from the media transmitting source. The multimedia playing apparatus includes an input module for inputting a user's instructions including a preferred media transmitting source, a search rule, and an output action; a reception module, responsive to the preferred media transmitting source, receiving the media descriptor corresponding to the digital multimedia information, outputting the media descriptor, and receiving the digital multimedia information; a comparison module comparing the media descriptor with the search rule; a control module, responsive to the output action, outputting a control signal; a recording module, selectively responsive to the control signal, recording the digital multimedia information; and a playing module, selectively responsive to the control signal, playing back the digital multimedia information.

The detailed embodiments, advantages and spirit of the present invention can be further understood by way of the following detailed descriptions and appended drawings.

### BRIEF DESCRIPTION OF DRAWINGS

The foregoing and advantages of the invention will be appreciated more fully from the following further description thereof with reference to the accompanying drawings wherein:

FIG. 1 is a schematic diagram of a multimedia playing apparatus of the present invention capable of searching for digital multimedia information.

FIG. 2 is a schematic diagram of another multimedia playing apparatus of the present invention capable of searching for digital multimedia information.

FIG. 3 is an example showing the items included in a media descriptor.

FIG. 4 is a schematic diagram of another multimedia playing apparatus of the present invention capable of searching for digital multimedia information.

FIG. 5 is a flow chart performed by the multimedia playing apparatus shown in FIG. 4.

### DETAILED DESCRIPTION OF SPECIFIC EMBODIMENTS

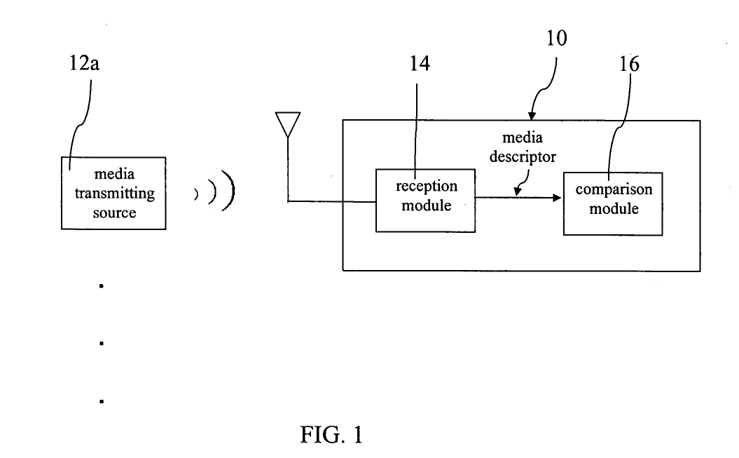

FIG. 1 is a schematic diagram of a multimedia playing apparatus of the present invention capable of searching for digital multimedia information. The multimedia playing apparatus 10 includes at least a reception module 14 and a comparison module 16. The reception module 14 receives digital multimedia information and the corresponding media descriptor from at least one or more media transmitting sources 12a. When the media descriptor is received by the reception module 14, the multimedia playing apparatus 10 starts a search, monitoring and control procedures.

For example, the multimedia information of RM format developed by RealNetworks™ is played back by Real Player at the reception end, the media descriptor including author name, title, and so on, are also displayed. Therefore, after the reception 14 receives at least the media descriptor corresponding to the digital multimedia information, the comparison module 16 compares the media descriptor with search rules to determine if the media descriptor conforms to the search rules. By doing so, a user can search desired multimedia programs from one or more specific or non-specific media transmitting sources 12a that is similar to a search engine, like Google.

In general, the digital multimedia information is divided into three types: video, picture, and audio. The exemplary formats of video type are RA, WMV, AVI, MPEG, and QuickTime. The exemplary formats of picture type are JPG, BMP, and TIFF. The exemplary formats of audio type are RA, WMA, MP3, WAVE, MIDI, and AIFF. The multimedia playing apparatus 10 compares and searches the aforementioned various types of formats for different kinds of digital multimedia information.

The reception module 14 of receives multimedia information from channels of Digital Audio Broadcasting (DAB), Digital Video Broadcasting (DVB), Internet Protocol Broadcasting, Digital Satellite Broadcasting (DSB), Digital Sound Broadcasting (DSB), Wifi, LAN, Bluetooth, Satellite, and so on. No matter what kind of digital broadcasting technology transmits the multimedia information, the multimedia playing apparatus 10 compares the media descriptor corresponding to the multimedia information, as long as the media descriptor is embedded in digital multimedia information, or the media descriptor is transmitted with digital multimedia information.

The reception module 14 is embodied by utilizing circuit components corresponding with digital broadcast techniques. The reception module 14 utilizes a conventional existing circuit kit which is well known in the art, so the detailed description of which is omitted here.

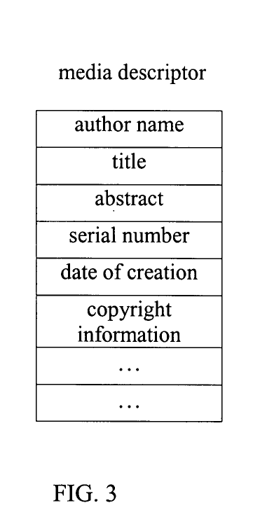

Since the media descriptor at least includes items of author name, title, abstract, serial number, date of creation, copyright information, and so on, as shown in FIG. 3, the search rule mainly consists of one or more media descriptor items. A comparison is implemented by the comparison module 16 on the basis of the search rules. For example, if a user wants to look for songs of singer “ABC” created in “1995”, the search rule can be “author name=ABC and date of creation=1995”. Further, adopting wildcard character ‘*’ in a comparison criterion enables a user to input the search rules more easily.

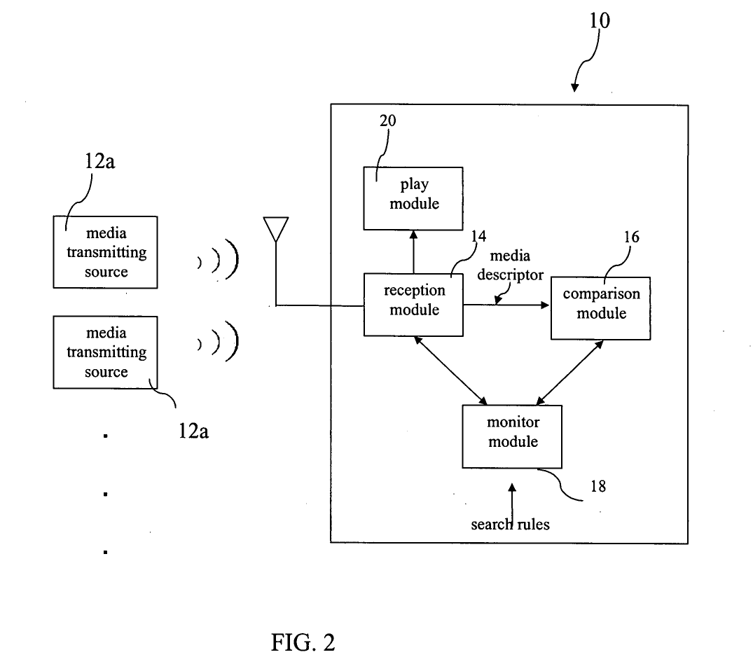

FIG. 2 is a schematic diagram of another multimedia playing apparatus of the present invention capable of searching for digital multimedia information. The multimedia playing apparatus 10 further includes a monitor module 18 and play module 20 in addition to the reception module 14 and the comparison module 16. The monitor module 18 is adapted to receive one or more search rules input by user, so as to make the multimedia playing apparatus 10 monitor the media descriptor transmitted by one or more media transmitting sources 12a as a monitor mode is activated.

After one or more search rules are input into the multimedia playing apparatus 10 by a user through any conventional operation interfaces, the multimedia playing apparatus 10 monitors the media descriptor provided by one or more media transmitting sources as a monitor mode is enabled. The conventional operation interface includes, for example, the display panel with handwriting function and keyboard.

When the monitor module 18 operates, the multimedia playing apparatus 10 enters the monitor mode, and the search rules can be input. Meanwhile, the multimedia playing apparatus 10 commands the reception module 14 to receive the media descriptor one by one from one or more media transmitting sources 12a, and commands the comparison module 16 to perform the comparison on the basis of the search rules. When the comparison result is determined to be HIT, the multimedia playing apparatus 10, for example, records the multimedia information currently transmitted, or immediately plays back the multimedia information through the play module 20. The multimedia information is selectively played in the default mode, or in high volume mode to catch the user's attention.

The multimedia playing apparatus 10 may be embodied in a portable multimedia information receiver/player apparatus, in an adaptor card of computer system for multimedia information reception/playback, in an information appliance for multimedia information reception/playback, or in an entertainment apparatus for multimedia information reception/playback.

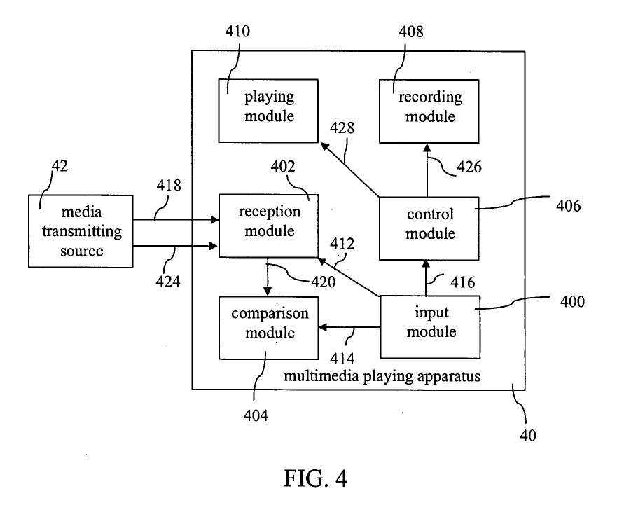

FIG. 4 is a schematic diagram of another multimedia playing apparatus 40 of the present invention capable of searching for digital multimedia information. In an exemplary embodiment, the digital multimedia information includes at least one of video information, photograph information, and audio information. As shown in FIG. 4, a media transmitting source 42 provides multimedia information including a corresponding media descriptor. In an exemplary embodiment, the media descriptor includes items of author name, title, abstract, serial number, date of creation, copyright information, and so on. In another exemplary embodiment, the digital multimedia information and the corresponding media descriptor are provided by one or more media transmitting sources. The multimedia playing apparatus 40 includes an input module 400, a comparison module 404, a control module 406, a recording module 408, and a playing module 410. The input module 400 is used for inputting a user's instructions including a preferred media transmitting source 412, a search rule 414, and an output action 416. More specifically, there is a plurality of media transmitting sources providing multimedia information. The user sets up the order of media transmitting sources to be searched, sets up the search rule to be compared, and sets up the output action to be performed. In an exemplary embodiment, the search rule includes at least one or more items of the media descriptor. The reception module 402, responsive to the preferred media transmitting source 412, receives the media descriptor 418 corresponding to the digital multimedia information, outputs the media descriptor 420, and receives the digital multimedia information 424. The comparison module 404 compares the media descriptor 420 with the search rule 414. The control module 406, responsive to the output action 416, outputs a control signal 426 to the recording module 408 or outputs a control signal 428 to the playing module 410. The recording module 408, selectively responsive to the control signal 426, records the digital multimedia information. The playing module 410, selectively responsive to the control signal 428, plays back the digital multimedia information. In an exemplary embodiment, the multimedia playing apparatus plays back the digital multimedia information in normal tone or high tone as the media descriptor being conformed to the search rule.

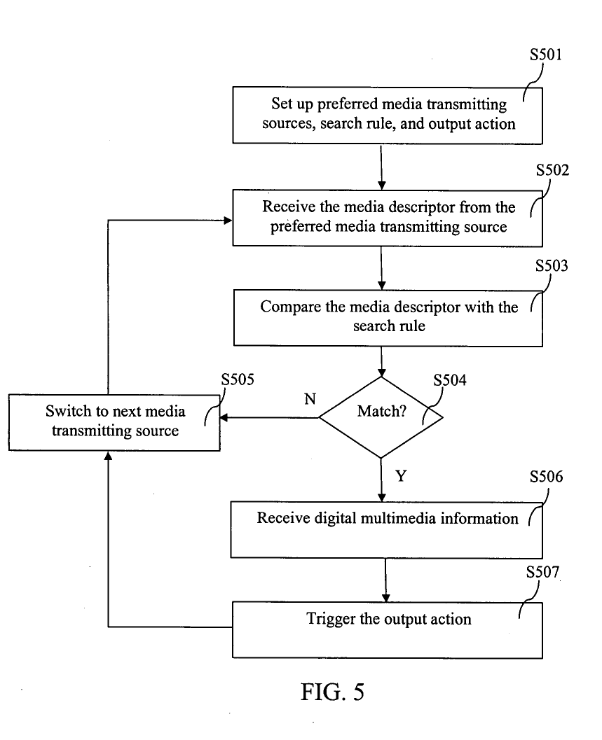

FIG. 5 is a flow chart performed by the multimedia playing apparatus shown in FIG. 4. In step S501, a user sets up preferred media transmitting sources, a search rule, and an output action, and the process proceeds to step S502. In step S502, the reception module 402 receives the media descriptor from the preferred media transmitting source, and the process proceeds to step S503. In step S503, the comparison module 404 compares the media descriptor with the search rule, and the process proceeds to step S504. If it is determined in step S504 that the media descriptor matches with the search rule, the process proceeds to step S506. Otherwise, the process proceeds to step S505. In step S505, the media transmitting source to be searched is switched to the next one of the preferred media transmitting sources set up by the user, and the process backs to step S502. In step S506, the reception module 402 receives the digital multimedia information from the media transmitting source, and the process proceeds to step S507. In step S507, the output action is triggered. More specifically, the received digital multimedia information can be recorded or played back according to the output action set up by the user. Then the process proceeds to step S505.

While various exemplary embodiments of the present invention are described herein, it should be noted that the present invention may be embodied in other specific forms, including various modifications and improvements, without departing from the sprit and scope of the present invention. Thus, the described embodiments are to be considered in all respects only as illustrative and not restrictive.

What is claimed is:

1. A multimedia playing apparatus capable of searching for digital multimedia information including a corresponding media descriptor while being downloaded from media transmitting source, the multimedia playing apparatus comprising:
a reception module for receiving at least the media descriptor; and
a comparison module for determining if the media descriptor conforms to a search rule.

2. A multimedia playing apparatus according to claim 1, wherein the digital multimedia information comprises at least one of video information, photograph information, and audio information.

3. A multimedia playing apparatus according to claim 2, wherein format of the video information comprises at least one of Divx, Xivd, H.264, RA format, WMV format, AVI format, MPEG format, and QuickTime format.

4. A multimedia playing apparatus according to claim 2, wherein format of the photograph information comprises at least one JPG format, BMP format, and TIFF format.

5. A multimedia playing apparatus according to claim 2, wherein format of the audio information comprises at least one of RA format, WMA format, MP3 format, WAVE format, MIDI format, and AIFF format.

6. A multimedia playing apparatus according to claim 1, wherein the reception module is configured to receive the digital multimedia information and the corresponding media descriptor by way of Wifi, LAN, Bluetooth, Satellite, Digital Audio Broadcasting (DAB), Digital Video Broadcasting (DVB), Internet Protocol Broadcasting, Digital Satellite Broadcasting (DSB), or Digital Sound Broadcasting (DSB).

7. A multimedia playing apparatus according to claim 1, wherein the media descriptor comprises at least one item of the group consisting of author name, title, abstract, serial number, date of creation, and copyright information.

8. A multimedia playing apparatus according to claim 7, wherein the search rule comprises at least one or more items of the media descriptor.

9. A multimedia playing apparatus according to claim 1, wherein the digital multimedia information and the corresponding media descriptor are provided by one or more media transmitting sources.

10. A multimedia playing apparatus according to claim 1, further comprising:
a monitor module for receiving the search rule input by a user, the monitor module, based on a monitor mode, monitors the media descriptor.

11. A multimedia playing apparatus according to claim 10, wherein in the monitor mode, the multimedia playing apparatus utilizes the reception module to receive the media descriptor one by one from one or more media transmitting sources and utilizes the comparison module to implement the determination operation.

12. A multimedia playing apparatus according to claim 1, wherein the multimedia playing apparatus records the digital multimedia information or plays back the digital multimedia information in normal tone or high tone as the media descriptor as being conformed to the search rule.

13. A multimedia playing apparatus according to claim 10, wherein in the monitor mode, the multimedia playing apparatus records the digital multimedia information or plays back the digital multimedia information in normal tone or high tone as the media descriptor is determined as being conformed to the search rule.

14. A multimedia playing apparatus capable of searching for digital multimedia information including a corresponding media descriptor while being downloaded from media transmitting source, the multimedia playing apparatus comprising:
an input module for inputting a user's instructions including a preferred media transmitting source, a search rule, and an output action;
a reception module, responsive to the preferred media transmitting source, receiving the media descriptor corresponding to the digital multimedia information, outputting the media descriptor, and receiving the digital multimedia information;
a comparison module comparing the media descriptor with the search rule;
a control module, responsive to the output action, outputting a control signal;
a recording module, selectively responsive to the control signal, recording the digital multimedia information; and
a playing module, selectively responsive to the control signal, playing back the digital multimedia information.

15. A multimedia playing apparatus according to claim 14, wherein the digital multimedia information comprises at least one of video information, photograph information, and audio information.

16. A multimedia playing apparatus according to claim 14, wherein the media descriptor comprises at least one item of the group consisting of author name, title, abstract, serial number, date of creation, and copyright information.

17. A multimedia playing apparatus according to claim 16, wherein the search rule comprises at least one or more items of the media descriptor.

18. A multimedia playing apparatus according to claim 14, wherein the digital multimedia information and the corresponding media descriptor are provided by one or more media transmitting sources.

19. A multimedia playing apparatus according to claim 14, wherein the multimedia playing apparatus records the digital multimedia information or plays back the digital multimedia information in normal tone or high tone as the media descriptor as being conformed to the search rule.
